(19) United States
(12) Patent Application Publication
(10) Pub. No.: US 2026/0218779 A1
(43) Pub. Date: Jul. 30, 2026

(54) Gearing, Drivetrain and Vehicle

(71) Applicant: ZF Friedrichshafen AG, Friedrichshafen (DE)

(72) Inventors: Matthias Reisch, Ravensburg (DE); Kim Führer, Lindau (DE); David Jonak, Langenargen (DE); Matthias Winkel, Weingarten (DE); Christian Gürlich, Ravensburg (DE); Tamas Gyarmati, Bermatingen (DE)

(21) Appl. No.: 19/462,615

(22) Filed: Jan. 28, 2026

(30) Foreign Application Priority Data
Jan. 30, 2025 (DE) 102025103404.4

(51) Int. Cl. F16H 3/66; F16H 1/46; F16H 3/00; F16H 3/62; F16H 57/04; F16H 57/08

(52) U.S. Cl. CPC F16H 3/66; F16H 1/46; F16H 3/006; F16H 3/62; F16H 57/043; F16H 57/082; F16H 2200/006; F16H 2200/2005; F16H 2200/2012; F16H 2200/2048

(57) ABSTRACT

A gearing for a vehicle includes an input shaft, an intermediate shaft, a first output shaft, a second output shaft, a first planetary gear set, a second planetary gear set, and a cylindrical gear gearing. The intermediate shaft is mechanically operatively connected to a third element of the first planetary gear set. The first output shaft is mechanically operatively connected to a second element of the first planetary gear set. A first element of the first planetary gear set is mechanically operatively connected to a first element of the second planetary gear set. The second output shaft is mechanically operatively connected to a third element of the second planetary gear set. The input shaft is mechanically operatively connected to the intermediate shaft via the cylindrical gear gearing. The gearing has a transmission ratio having an absolute value greater than ten between the input shaft and the output shafts.

### CROSS-REFERENCE TO RELATED APPLICATION

The present application is related and has right of priority to German Patent Application No. 10 2025 103 404.4 filed on Jan. 30, 2025, the entirety of which is incorporated by reference for all purposes.

### FIELD OF THE INVENTION

The present disclosure relates generally to a gearing for a vehicle. The disclosure also relates generally to a drivetrain having such a gearing and generally to a vehicle.

### BACKGROUND

Gearings for vehicles are known. In some cases, the gearing may have one or more gear sets for converting an input rotational speed into another, for example lower, output rotational speed. In some cases, the gearing may be arranged in a transverse direction of the vehicle between two driving elements, for example wheels, which are operatively connected to the gearing for driving the vehicle. In such cases, the available space for the gear sets between the driving elements may be limited.

### SUMMARY OF THE INVENTION

The present disclosure relates in a first aspect to a gearing for a vehicle. Examples of the vehicle may include a passenger car, a truck, a bus, and a work machine. Examples of the work machine may include a tractor, a combine harvester, a municipal vehicle such as a road sweeper, an excavator, and a wheel loader. The vehicle may have a drive apparatus for directly or indirectly driving the vehicle by introducing power into the gearing. The gearing and the drive apparatus may form a drivetrain for driving the vehicle. The drive apparatus may have an internal combustion engine, a hydraulic motor, and/or an electric motor. The electric motor may have an externally excited synchronous machine and/or an asynchronous machine. Alternatively, or additionally, the electric motor may have a permanently excited synchronous machine. The drive apparatus may receive energy from an energy storage device, for example a tank or a battery, and convert it into rotational mechanical energy, for example into a drive power for the gearing. The drive apparatus may further have apparatuses for converting electrical energy, for example a voltage converter and/or an inverter.

The gearing has an input shaft, a first output shaft, and a second output shaft. At least one of the output shafts of the gearing may be mechanically operatively connected to a drive element of the vehicle. The drive element may be, for example, a wheel for contacting the ground or a drive wheel or sprocket for chains. The gearing may be configured to convert an input variable, for example a rotational speed and/or a torque at the input shaft, into an output variable of different magnitude at the output shafts. For example, the gearing may be configured to convert an input rotational speed into another, for example lower, output rotational speed depending on a transmission ratio. The gearing may alternatively, or additionally, be configured as a distribution gearing for distributing a power at the input shaft to the two output shafts. The gearing may also have a differential function in order to enable a relative rotation between the output shafts. Furthermore, the gearing has an intermediate shaft which may be arranged in the power flow between the input shaft and at least one output shaft.

If two elements are mechanically operatively connected, they are directly or indirectly coupled to one another such that a movement of one element causes a reaction of the other element. A mechanical operative connection may be produced, for example, by a frictional connection or a positive connection between the elements. The mechanical operative connection may correspond to an engagement between corresponding gearwheels of the two elements. Further elements, such as shafts, constant velocity joints and/or one or more gear sets, may be present between the elements. If two elements are permanently, non-rotatably connected to one another, these elements are rigidly coupled to one another for all intended states of the gearing such that they rotate at the same speed. Permanently, non-rotatably connected elements may be formed integrally, for example monolithically. They may also be non-rotatably connected to one another by a mechanical connection, for example a cohesive connection, such as by welding, or a screw connection. Two elements may be non-rotatably connectable to one another via a shift element. For example, a non-rotatable connection may be selectively engaged or disengaged between elements via the shift element. A shift element may be configured as a frictional shift element, for example as a multi-disk clutch, or as a positive shift element, for example as a dog clutch. A positive shift element may also be configured to selectively non-rotatably engage or disengage two splines with one another.

The gearing further has a first planetary gear set and a second planetary gear set as well as a cylindrical gear gearing. In addition to the first and the second planetary gear sets, the gearing may also have further planetary gear sets. The cylindrical gear gearing may have one or more cylindrical gear stages. The first planetary gear set and the second planetary gear set each have a first element, a second element, and a third element. Examples of the elements of the planetary gear sets may include a sun gear, a planetary carrier, and a ring gear. Each of the planetary gear sets may have one or more planetary gears which may be rotatably supported on the respective planetary carrier, for example, in each case, via a planetary pin. The planetary gears may mesh both with the sun gear and with the ring gear of the respective planetary gear set. The respective planetary gear set may be a plus planetary gear set or a minus planetary gear set. The first planetary gear set and the second planetary gear set may be configured identically or differently from each other. Thus, for example, the first elements of the planetary gear sets may both be a sun gear or may be different from each other. In an embodiment, for example, the first element of the first planetary gear set is a ring gear and the first element of the second planetary gear set is a sun gear. The same applies to the second and third elements of the planetary gear sets.

The input shaft is mechanically operatively connected to the intermediate shaft via the cylindrical gear gearing. Further components, for example further gearings, may be arranged in the power flow between the input shaft and the intermediate shaft in addition to the cylindrical gear gearing. In an embodiment, exclusively the cylindrical gear gearing is provided in the power flow from the input shaft to the intermediate shaft. The intermediate shaft may also be a component of the cylindrical gear gearing. As stated above, the cylindrical gear gearing may have one or more cylindrical gear stages. In an embodiment, the cylindrical gear gearing has a single single-stage cylindrical gear stage. The input shaft may be permanently, non-rotatably connected to a gear of the cylindrical gear gearing, for example via a non-rotatable spline. The intermediate shaft may be permanently, non-rotatably connected to a further cylindrical gear of the cylindrical gear gearing, for example by an integral, for example monolithic, formation. The input shaft and the intermediate shaft may be arranged axially parallel and spaced apart from the first and second output shafts. In an embodiment, the input shaft is a rotor shaft of the drive apparatus.

The first and the second planetary gear sets may be arranged coaxially to each other and alternatively, or additionally, coaxially to the first and the second output shafts. The first and the second planetary gear sets may be arranged one behind the other in an axial direction of the gearing, wherein either the first or the second planetary gear set may be arranged in the axial direction between the drive apparatus and the respective other planetary gear set. A drive apparatus coupled to the input shaft may be arranged axially parallel and spaced apart from the first and second output shafts.

The intermediate shaft is mechanically operatively connected to the third element of the first planetary gear set. In an embodiment, the third element is a ring gear, wherein, as described above, the third element may instead be a planetary carrier or sun gear. Further elements may be arranged in the power flow between the intermediate shaft and the third element of the first planetary gear set. The first element of the first planetary gear set is mechanically operatively connected to the first element of the second planetary gear set. Further elements may be arranged in the power flow between the first elements of the two planetary gear sets. In an embodiment, the two first elements of the planetary gear sets are sun gears, wherein, as described above, one or both first elements may instead be a planetary carrier and/or a ring gear. The first output shaft is mechanically operatively connected to the second element of the first planetary gear set. The second output shaft is mechanically operatively connected to the third element of the second planetary gear set. Further elements may be arranged in the power flow between the elements of the planetary gear sets and the output shafts. In an embodiment, the second element of the first planetary gear set is a planetary carrier and the third element of the second planetary gear set is a ring gear, wherein, as described above, the elements may each also be formed differently.

The gearing of the present disclosure is configured such that there is a transmission ratio between the input shaft and the two output shafts which is greater than 10 in terms of absolute value. For example, a reduction, i.e. a speed reduction transmission, may be provided between the input shaft and the two output shafts. Here, both the cylindrical gear gearing and the two planetary gear sets together may each provide a reduction. The reduction provided by the gearing as a whole, i.e. the reduction combined by the planetary gear sets and the cylindrical gear gearing, may be at least 10 in terms of absolute value. By such a configuration, a gearing having a particularly high reduction is provided. In an embodiment, the gearing is configured to provide a transmission ratio between the input shaft and the two output shafts which is greater than 15 in terms of absolute value.

A gearing having such a high reduction allows it to be coupled to a very fast-rotating electric motor. Thus, the gearing may be operated, for example, by an electric motor which may provide a rotational speed of the rotor shaft of more than 10,000 revolutions per minute, for example more than 20,000 revolutions per minute. Such a very fast-rotating electric motor may be particularly compact. Such high-speed electric motors require small rotor shaft diameters, which may be realized particularly in the case of an axially parallel arrangement of the electric motor with respect to the output shafts. By the provided cylindrical gear gearing of the present invention, such a connection of the axially parallel electric motor to the planetary gear sets may be provided, wherein the cylindrical gear gearing may at the same time reduce the very high rotational speeds of the electric motor. At the same time, a further reduction may be provided via the planetary gear sets and, in addition, the power of the electric motor may be distributed to the two output shafts. In addition, the two planetary gear sets may provide a differential functionality which enables a relative rotation of the two output shafts, for example during cornering. In summary, the gearing of the present invention thus enables a particularly compact and at the same time efficient axle drive which, due to its high reduction, enables the use of very fast-rotating electric motors having a particularly compact configuration.

In an embodiment, the gearing is configured to transmit a power from the intermediate shaft to the two output shafts with a distributor transmission ratio. A transmission ratio of the cylindrical gear gearing may be greater than the distributor transmission ratio in terms of absolute value. For example, the transmission ratio of the cylindrical gear gearing may be greater than 4, in an embodiment greater than 5, in terms of absolute value. In an embodiment, the distributor transmission ratio may be between 2 and 4, for example between 2.5 and 3.5. In an alternative embodiment, the transmission ratio of the cylindrical gear gearing may be smaller than the distributor transmission ratio.

In an embodiment, the cylindrical gear gearing has a cylindrical gear which is permanently, non-rotatably connected to the third element of the first planetary gear set. The cylindrical gear may form the intermediate shaft. For example, the cylindrical gear of the cylindrical gear gearing and the third element of the first planetary gear set are formed monolithically. The cylindrical gear may also form the intermediate shaft monolithically in addition to the third element of the first planetary gear set. This has the advantage of a high mechanical strength and at the same time relatively low costs. In an alternative embodiment, the cylindrical gear of the cylindrical gear gearing and the third element of the first planetary gear set are non-rotatably connected to one another via a separate carrier element. In such an embodiment, the cylindrical gear may form the intermediate shaft monolithically, wherein the intermediate shaft is now non-rotatably connected to the third element of the first planetary gear set via the carrier element. The carrier element may be a carrier plate. The carrier plate may be non-rotatably connected to at least one of the two elements which it couples, for example via a spline. The spline may be configured to transmit a torque and optionally enable axial and/or radial compensating movements. The carrier plate may be provided with an additional axial securing means, for example by a support ring or snap ring. Alternatively, or additionally, one of the elements, for example the ring gear, may be secured axially relative to the carrier plate by deforming the carrier plate. Alternatively, or additionally, the carrier plate may be permanently, non-rotatably connected to at least one of the two elements, for example by being welded or formed monolithically. Via the carrier element, the third element of the first planetary gear set may be decoupled from the intermediate shaft and the cylindrical gear such that it may align itself better. This results in an improvement in the acoustics and service life.

In an embodiment, toothed portions of the cylindrical gear and of the third element of the first planetary gear set have substantially the same pitches. The toothed portions of the cylindrical gear and of the third element of the first planetary gear set may be configured with helical toothings, wherein these helical toothings have pitches which substantially correspond to each other. The pitches of the toothed portions of the cylindrical gear and of the third element of the first planetary gear set may be matched to each other such that axial forces caused by the toothed portions on the cylindrical gear substantially cancel each other out. A substantial cancelation is understood here to mean a state in which the toothed portions with their pitches are designed for mutual compensation of the axial forces. Nevertheless, parasitic axial forces may occur during operation on account of manufacturing tolerances and/or disturbance variables. For example, the resulting axial forces compensate each other out with a degree of compensation of 95% or more. The pitch of a helical toothing may be understood to mean the axial path measured along an associated rotational axis, which is required in a mental or projected continuation of a tooth beyond the actual width of the gear in order to effect a 360° wrap of the tooth around the axis. In the case of threads, the term “thread pitch” is used in an analogous manner. A helically toothed gear having a plurality of teeth is thus comparable to a multi-start thread. In the case of spindles, the word “lead” is also used for the corresponding dimension.

In an embodiment, the cylindrical gear gearing has a support portion which is permanently, non-rotatably connected to the cylindrical gear. In an embodiment, the support portion is formed monolithically with the cylindrical gear. In an embodiment, the support portion is welded to the cylindrical gear. The support portion may extend substantially in the axial direction of the gearing and be connected to the cylindrical gear via a radial web. The support portion is supported with respect to a further gearing component, for example the gearing housing and/or a shaft, for example an output shaft. For this purpose, in an embodiment, one or more radial and/or axial bearings may be provided. Thereby, the gearing is designed such that a bending moment of the cylindrical gear may be supported via the support portion, for example on the housing or one of the output shafts. Such a configuration is advantageous in particular when the cylindrical gear has a relatively large effective diameter and is thus exposed to high loads.

If the support portion is supported on the housing, a particularly stiff support having good acoustics and a long service life may be provided. If, on the other hand, the support portion is supported on a shaft, for example an output shaft, and thus not directly on the housing, a particularly compact configuration may be achieved. In an embodiment, the support portion is supported on the first output shaft. In such an embodiment, the cylindrical gear may be supported directly on a stationary member, for example a housing, with only a single bearing. A direct support on the stationary member, for example a housing, may be understood to mean a support in which no further components with the exception of the bearing are provided between the part to be supported and the stationary member. On the other hand, in an indirect support on the stationary member, for example a housing, further components, for example a shaft, may be arranged between the member to be supported and the stationary member. The single bearing may be configured as a roller bearing, for example as a cylindrical roller bearing. In such a configuration, the bearings may further have a small diameter, which is advantageous for the costs and losses.

In an embodiment, the cylindrical gear is supported in an axially floating manner, so that it may move in the axial direction with a certain clearance. This simplifies, among other things, the assembly. The cylindrical gear gearing may have a further cylindrical gear which meshes with the cylindrical gear supported in an axially floating manner. For supporting the floatingly supported cylindrical gear in an axial direction, a thrust ring may be provided on the further cylindrical gear. The thrust ring (abutment ring) may have a shape corresponding to a pressure comb and thus enable a friction-optimized point or line contact with the cylindrical gear. In the other axial direction, the floatingly supported cylindrical gear may be supported on the stationary member via one or more bearings. For example, the floatingly supported cylindrical gear may be supported on the stationary member in the axial direction via the single bearing via which the support portion is supported directly on the stationary member. Alternatively, or additionally, the floatingly supported cylindrical gear may also be supported in the other axial direction by a thrust ring which may be provided for example on the further cylindrical gear. Thus, a limitation of the axial clearance of the cylindrical gear supported in a floating manner is possible in a simple manner.

In an alternative embodiment, the second element of the first planetary gear set is axially supported on the support portion via an axial bearing, for example via an axial roller bearing, such as an axial needle bearing. The cylindrical gear may be axially fixed by the axial bearing and one or more further bearings, for example the single bearing, so that it is no longer supported in a floating manner. In such a configuration, the thrust ring provided on the further cylindrical gear of the cylindrical gear gearing for axially fixing the cylindrical gear may then be omitted.

In an embodiment, the second element of the first planetary gear set is fixed to the first output shaft in at least one axial direction, for example in both axial directions, via a retaining element. The retaining element may be a retaining ring and/or snap ring or another configuration. The retaining element may fix the second element of the first planetary gear set relative to the first output shaft in both axial directions. Thus, the number of axial bearings may be reduced, which leads to a cost saving.

In an embodiment, the first output shaft is supported with respect to the second output shaft. Here, one, two or more radial bearings may be provided in order to support the first output shaft radially with respect to the second output shaft. The radial bearings may be rolling bearings and/or plain bearings. In an embodiment, the radial bearings are needle bearings. If the first output shaft is supported with respect to the second output shaft by two radial bearings, a comparatively cost-effective and simple support of the output shafts on the housing may be provided. That is, it is not necessary in such a case that each output shaft may introduce a bending moment into the housing per se. Instead, each of the output shafts may be supported relative to the housing with only a single bearing. If, on the other hand, the first output shaft is supported relative to the second output shaft with only a single radial bearing, this leads to a comparatively simple and less complex support of the two output shafts relative to one another. At the same time, in this case, one of the output shafts may be supported in a torsionally rigid manner relative to the housing, for example via two bearings. The torsionally rigid support may be effected directly and/or indirectly in the housing. In order to provide the radial support between the first output shaft and the second output shaft, the first output shaft and the second output shaft may overlap axially, wherein the radial bearing or bearings may be arranged in the region of the overlap. Here, the first output shaft may be arranged radially within the second output shaft in the overlap region. Alternatively, the second output shaft may also be arranged radially within the first output shaft in the overlap region.

In an embodiment, the first output shaft is supported with respect to the second output shaft such that an axial force transmission between the output shafts is possible in at least one axial direction, for example in both axial directions. The axial force transmission may be realized here for example by at least one of an axial abutment, a snap ring, a retaining ring and a screw connection between the output shafts. The gearing may be configured such that axial forces are transmitted from the first output shaft to the second output shaft and vice versa in a loss-free manner. The gearing may be configured such that there is no rotational speed difference between the first and the second output shaft during straight-ahead travel. By such a configuration, axial forces may be transmitted between the two output shafts, so that a smaller number of axial bearings is required. For example, the output shafts may abut each other in one axial direction and be axially fixed to each other in the other axial direction via a retaining element, for example a retaining ring and/or snap ring.

In an embodiment, the toothed portions of the first element of the first planetary gear set and of the first element of the second planetary gear set have substantially the same pitches. The toothed portions of the first elements of the planetary gear sets may be configured with helical toothings, wherein these helical toothings have pitches which substantially correspond to each other. The pitches of the toothed portions may be matched to each other such that axial forces caused by the toothed portions on a coupling element, which may permanently, non-rotatably connect the two first elements of the planetary gear sets, substantially cancel each other out. A substantial cancelation is understood here to mean a state in which the toothed portions with their pitches are designed for mutual compensation of the axial forces. Nevertheless, parasitic axial forces may occur during operation on account of manufacturing tolerances and/or disturbance variables. For example, the resulting axial forces compensate each other out with a degree of compensation of 95% or more.

Here, at least one of the first elements of the planetary gear sets may be supported in one axial direction via at least one of an abutment on a planetary gear of the planetary gear sets, an abutment on a planetary carrier of the planetary gear sets and an axial bearing. For example, a coupling element, via which the first elements of the planetary gear sets may be permanently, non-rotatably connected to one another, has an abutment portion via which the coupling element may be supported on the planetary gears of the second planetary gear set in one axial direction. Furthermore, this coupling element may have a thrust ring via which the coupling element may be supported on the planetary gears of the first planetary gear set in the other axial direction. For this purpose, for example, thrust plates for the planetary gears, which may each be arranged on the respective planetary carrier, may have recesses in order to enable the abutment portion and the thrust ring to run against the respective planetary gears. Here, the thrust plates may be provided on the respective planetary carriers in a manner secured against rotation in order to provide a rotational alignment of the recesses with respect to the abutment portion and the thrust ring. Alternatively, the coupling element may also abut an adjacent member, for example a planetary carrier, for axial support. Furthermore, the coupling element may be supported via an axial bearing on another member for axial fixation. A combination of these configurations is also possible. In an embodiment, the pitches of the toothings of the first elements of the planetary gear sets have a difference which may be small in order to enable, for example in a pull mode, a preferred, for example efficiency-friendly, abutment.

In an embodiment, the first planetary gear set has more planetary gears than the second planetary gear set. For example, the first planetary gear set may have five to six planetary gears and the second planetary gear set may have three to four planetary gears. Such a configuration leads to advantageous transmission ratios with a high efficiency and a high mechanical strength.

In an embodiment, the second element of the second planetary gear set is selectively non-rotatably connectable to a stationary member, for example a gearing housing, via a shift element. Thus, a disconnect functionality may be provided in which the drive apparatus may assume any desired rotational speed, for example in order to synchronize one of the gears, or may be stationary in order to reduce drag torques. Furthermore, in an embodiment, the second element of the second planetary gear set may be selectively non-rotatably connected to the third element of the first planetary gear set via the shift element. In such a shift state, the planetary gear sets have no connection to a stationary member, so that a transmission having a transmission ratio of 1 is provided by them. In such a shift position, a further gear may thus be provided in which there is only the transmission of the cylindrical gear stage. However, the planetary gear sets may still provide a differential functionality.

In an embodiment, the gearing has a lubricant supply for supplying lubricant into the first output shaft and from the same to a gearing element. The gearing element may be at least one first element of the first or second planetary gear set or a bearing, for example a bearing between the output shafts. For example, a lubricant is supplied into the interior of the first output shaft via the lubricant supply. From the latter, the lubricant may reach the first element of the first and/or second planetary gear set, for example in order to cool and lubricate the toothings thereof. For supplying the lubricant into the interior of the first output shaft, a housing-fixed lubricant nozzle may be provided which conveys lubricant through one or more openings in the first output shaft into the interior thereof. Thereby, the sealing maybe simplified, for example by omitting rectangular ring seals, which leads to a cost advantage, a simplification of assembly and/or a reduction of drag torques.

In an embodiment, the gearing has a lubricant catching apparatus for catching lubricant for lubricating an element of a planetary gear set. In an embodiment, the lubricant catching apparatus is configured to catch lubricant coming from the first element of the first planetary gear set. In a further embodiment, the lubricant catching apparatus is configured to catch lubricant coming from the second element of the second planetary gear set. For example, the lubricant catching apparatus is provided on the second element of the first planetary gear set. Between the first element of the first planetary gear set and the first element of the second planetary gear set, at least one opening may be provided through which lubricant coming from the interior of the first output shaft may pass radially outwardly. For example, the above-described coupling element may have such an opening. Such a lubricant which has passed through the opening may be captured by the lubricant catching apparatus in order to lubricate the further element of the planetary gear set. The element of the planetary gear set may be bearings via which planetary gears are supported on a planetary pin.

In an embodiment, the gearing has a further lubricant supply for supplying lubricant to the second element of the second planetary gear set. The further lubricant supply may be different from the first lubricant supply. In an embodiment, both lubricant supplies are supplied with lubricant by the same lubricant source. The further lubricant supply may include, for example, an annular channel in the second element of the second planetary gear set, via which different radial bores within the second element of the second planetary gear set may be supplied with lubricant. The radial bores may lead to planetary pins of the second planetary gear set in order to supply lubricant from the annular channel via the planetary pins to bearings of the planetary gears of the second planetary gear set for lubrication. The further lubricant supply may be configured to guide lubricant to the lubricant catching apparatus. By such a supply of lubricant via the further lubricant supply to the lubricant catching apparatus, a required lubricant flow in the first output shaft maybe reduced. This is advantageous in particular when the lubricant is introduced into the first output shaft via the housing-fixed lubricant nozzle and the opening in the output shaft.

Here, the further lubricant supply may have a separate plastic member which provides a fluidic connection to a housing-fixed oil channel. The aperture cross-sections of the plastic member may limit the lubricant flow to the planetary pins of the second planetary gear set. The plastic member may be clipped onto or clipped into the second element of the second planetary gear set. It may be a circumferential annular member. The plastic member may have a further outlet opening for guiding, for example spraying, the lubricant to the lubricant catching apparatus of the first planetary gear set in the above-described manner.

In an embodiment, the second element of the second planetary gear set is non-rotatably connected or non-rotatably connectable to a stationary member, for example a gearing housing, for example via the above-described shift element. Within the scope of this embodiment, the first element of the first planetary gear set may be permanently, non-rotatably connected to the first element of the second planetary gear set. For example, a hub of the first element of the first planetary gear set and a hub of the first element of the second planetary gear set are formed rigidly to one another, for example by welding, and thus together form a coupling element. The first elements of the first and second planetary gear set may each be a sun gear. Accordingly, within the scope of such a configuration, the two sun gears of the two planetary gear sets are permanently, non-rotatably coupled to one another. Such a configuration may lead to a high efficiency. The second elements of the first and second planetary gear set may each be a planetary carrier and the third elements of the first and second planetary gear set may each be a ring gear. Thus, a gearing having a high reduction, a high efficiency and a particularly compact configuration having the advantages described above may be provided. In a further embodiment (not shown), the first element of the first planetary gear set is a ring gear and the third element of the first planetary gear set is a sun gear.

In a second aspect, the present disclosure relates to a drivetrain having a drive apparatus and a gearing according to the first aspect. The drivetrain may for example form a drive axle of the vehicle, for example a front axle or a rear axle. The drive apparatus may have an electric motor having a rotor and a rotor shaft which is coupled to the rotor for transmitting torque. The respective advantages and further features maybe taken from the description of the first aspect, wherein embodiments of the first aspect also form embodiments of the second aspect and vice versa.

In an embodiment, the drive apparatus, for example the electric motor, is arranged axially parallel and spaced apart from the planetary gear sets and the output shafts. Thereby, a radial installation space on one side of the output shafts, for example on an upper side, may be used for accommodating the drive apparatus such that an installation space remains free on the other side of the output shafts, for example on a lower side. This is particularly advantageous when the drivetrain is used in a vehicle in which the ground clearance below the vehicle is restricted. The drive apparatus, for example the rotor shaft of the electric motor, may be mechanically operatively connected to the one element of the planetary gear set via the cylindrical gear. For example, the cylindrical gear may be configured as part of the above-described cylindrical gear stage. Thereby, a transmission ratio of the drivetrain between the electric motor and the output shafts may be large. The drive apparatus may further be arranged next to an output shaft bearing, a lubricant supply and/or side shaft joints.

In an embodiment, the drive apparatus has an electric motor having a rotor and a stator, wherein the stator and the rotor do not overlap the planetary gear sets in the axial direction. Here, the electric motor, for example the stator and/or the rotor, may at least partially overlap the planetary gear sets in the radial direction. Thus, a radial installation space requirement of the drivetrain may be low. In an embodiment, the first planetary gear set is arranged in the axial direction between the second planetary gear set and the drive apparatus. This enables a particularly compact configuration. In an embodiment, the cylindrical gear is arranged in the axial direction between the first planetary gear set and the drive apparatus. This also enables a particularly compact configuration. In case a support portion is provided for the cylindrical gear and the drive apparatus has an electric motor, the support portion may at least partially overlap at least one of the stator and the rotor of the electric motor in the axial direction.

In an embodiment, a further cylindrical gear of the cylindrical gear gearing is non-rotatably connected to a rotor shaft of the drive apparatus via a spline. For example, the further cylindrical gear together with the cylindrical gear may form the above-described cylindrical gear stage or be a part thereof. The further cylindrical gear may be removably attached to the rotor shaft of the drive apparatus via the spline. In case the input shaft is formed separately from the rotor shaft and non-rotatably connected thereto, the further cylindrical gear may be removably attached to the input shaft and non-rotatably connected thereto. The rotor shaft may be supported in a stationary member, for example a housing portion, via one or more rotor shaft bearings. A rotor shaft bearing may be arranged axially between the further cylindrical gear and a rotor of the drive apparatus. An inner diameter of the further cylindrical gear may be smaller than an inner diameter of this rotor shaft bearing. The further cylindrical gear may be supported via the input shaft and/or the rotor shaft. Alternatively, or additionally, the further cylindrical gear may be supported via a cylindrical gear bearing. The cylindrical gear bearing may, for example, be arranged on a side of the further cylindrical gear facing away from the rotor shaft. By the present embodiment, a simple assembly and support of the rotor shaft, the input shaft and the further cylindrical gear is achieved.

The present disclosure further relates in a third aspect to a vehicle having a drivetrain according to the second aspect or a gearing according to the first aspect. The respective advantages and further features maybe taken from the description of the first or second aspect, wherein embodiments of the first or second aspect also form embodiments of the third aspect and vice versa.

### BRIEF DESCRIPTION OF THE DRAWINGS

FIG. 1 shows a vehicle having a gearing according to an embodiment of the present disclosure.

FIG. 2 schematically shows a general interconnection of a gearing for the vehicle of FIG. 1 according to an embodiment of the present disclosure.

FIG. 3 schematically shows a drivetrain having a gearing having the interconnection of FIG. 2 according to an embodiment of the present disclosure.

FIG. 3a shows the gearing of the drivetrain of FIG. 3 in a detailed view.

FIG. 4 schematically shows a drivetrain having a gearing having the interconnection of FIG. 2 according to an embodiment of the present disclosure.

FIG. 5 schematically shows a drivetrain having a gearing having the interconnection of FIG. 2 according to an embodiment of the present disclosure.

FIG. 5a shows the gearing of the drivetrain of FIG. 5 in a detailed view.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

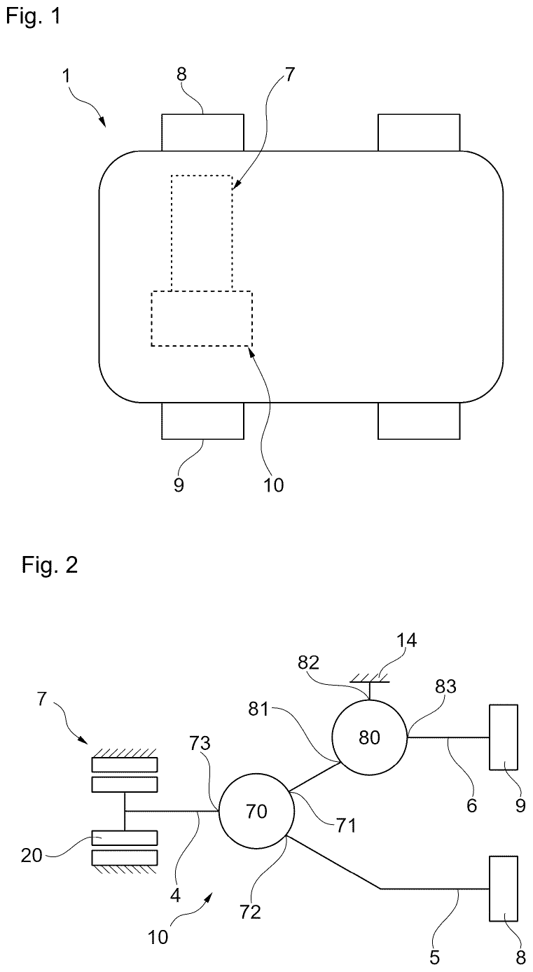

FIG. 1 shows a vehicle 1 having a gearing 10 according to an embodiment of the present disclosure. The vehicle 1 has a drive apparatus 7, which is presently configured as an electric motor. The gearing 10 is configured to transmit power, which is introduced by the drive apparatus 7, to at least two drive elements 8, 9, which in the present case are configured as wheels. The drive apparatus 7 and the gearing 10 together form a drivetrain for driving the wheels 8, 9.

FIG. 2 schematically shows a general interconnection of the gearing 10 according to an embodiment of the present disclosure. In the present embodiment, the gearing 10 is configured as a differential or distribution gearing having two planetary gear sets 70, 80. As maybe seen from FIG. 2, the a first planetary gear set 70 has a first element 71, a second element 72, and a third element 73. Furthermore, the second planetary gear set 80 has a first element 81, a second element 82, and a third element 83. Power, which is generated by the drive apparatus 7, may be introduced into the gearing 10 via an input shaft 4. The input shaft 4 is, for example, a rotor shaft of the drive apparatus and is mechanically operatively connected to the third element 73 of the first planetary gear set 70, for example via a pre-reduction stage (not shown in FIG. 2). The first element 71 of the first planetary gear set 70 is permanently, non-rotatably connected to the first element 81 of the second planetary gear set 80. The second element 82 of the second planetary gear set 80 is permanently, non-rotatably fixed to a stationary member 14 or non-rotatably fixable thereto. A first output shaft 5 is mechanically operatively connected to the second element 72 of the first planetary gear set 70, in this case permanently, non-rotatably connected, in order to output power to the first drive element 8. A second output shaft 6 is mechanically operatively connected to the third element 83 of the second planetary gear set 80, in this case permanently, non-rotatably connected, in order to output power to the second drive element 9.

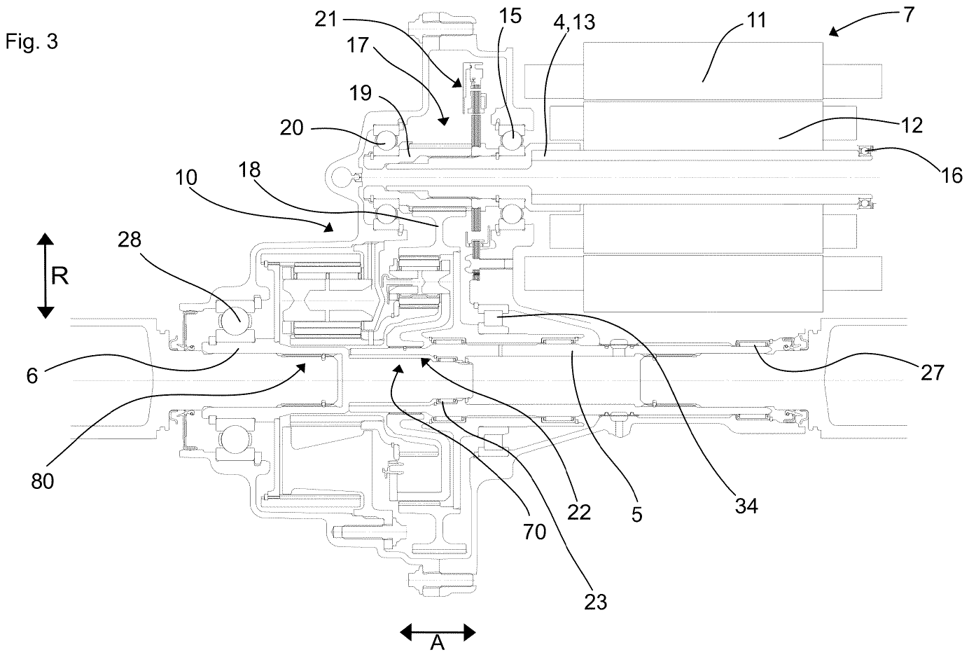

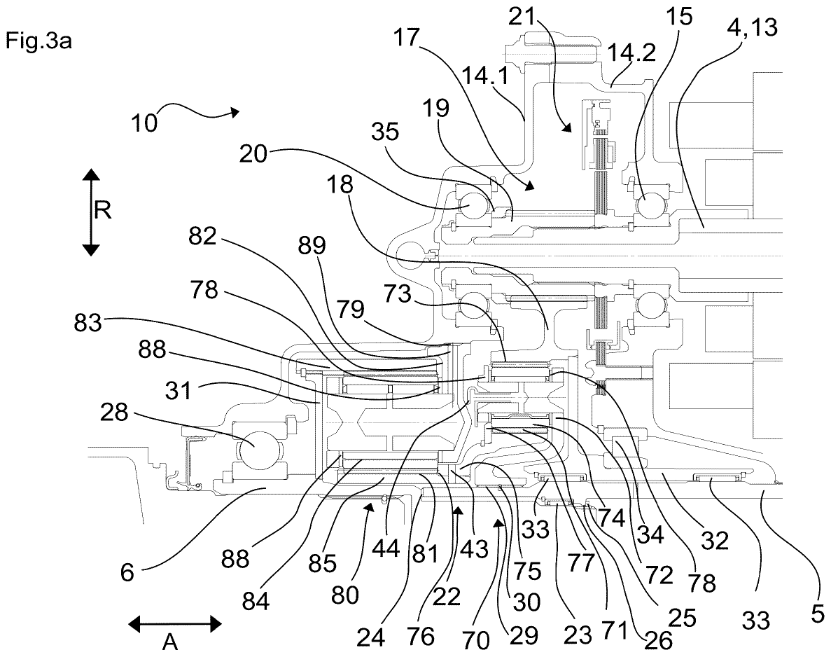

FIG. 3 shows a drivetrain having a gearing 10 according to an embodiment of the present disclosure. FIG. 3a shows the gearing 10 of the drivetrain of FIG. 3 in a detailed view. The embodiment will be described in the following with reference to both FIGS. 3 and 3a. The gearing 10 of the present embodiment is configured in accordance with the interconnection shown in FIG. 2. In the present embodiment, each of the first elements 71, 81 of the planetary gear sets 70, 80 is a sun gear, each of the second elements 72, 82 of the planetary gear sets 70, 80 is a planetary carrier, and each of the third elements 73, 83 of the planetary gear sets 70, 80 is a ring gear. Furthermore, the first planetary gear set 70 and the second planetary gear set 80 are provided offset along an axial direction A, i.e. arranged one behind the other. The first output shaft 5 is permanently, non-rotatably connected to the planetary carrier 72 of the first planetary gear set 70. The second output shaft 6 is permanently, non-rotatably connected to the ring gear 83 of the second planetary gear set 80 via a coupling portion 31. The first output shaft 5, the second output shaft 6, the first planetary gear set 70, and the second planetary gear set 80 are arranged coaxially to each other. The drive apparatus 7 configured as an electric motor is arranged axially parallel and axially spaced apart from the output shafts 5, 6 and the planetary gear sets 70, 80.

The drive apparatus configured as an electric motor has a stator 11 and a rotor 12, wherein the rotor 12 is provided within the stator 11 and coaxially thereto. The gearing 10 and the drive apparatus 7 are arranged one behind the other in the axial direction A. Here, the stator 11 and the rotor 12 of the drive apparatus 7 have no overlap whatsoever with the planetary gear sets 70, 80 of the gearing 10 in the axial direction A. Thus, a compact radial installation space is possible since the planetary gear sets 70, 80 of the gearing 10 and the stator 11 as well as the rotor 12 of the drive apparatus 7 may be provided at the same radial installation space height. The drive apparatus 7 has a rotor shaft 13 which is permanently, non-rotatably connected to the rotor 12. The rotor shaft 13 extends towards the gearing 10 and is arranged radially outside the first and second planetary gear set 70, 80. Here, the rotor shaft 13 overlaps the first planetary gear set 70 in the axial direction A.

The gearing 10 has two housing portions 14.1, 14.2 which are screwed to one another. The housing portions 14.1, 14.2 are provided stacked in the axial direction A, wherein the housing portion 14.2 is provided facing or closest the electric motor 7 and the housing portion 14.1 is provided facing away from the electric motor 7. The first housing portion 14.1 is substantially configured for receiving the planetary gear sets 70, 80. The second housing portion 14.2 is substantially configured for receiving the electric motor 7. In FIG. 3, only partial portions of the second housing portion 14.2 are shown.

The rotor shaft 13 is formed in a hollow manner and supported in the second housing portion 14.2 of the gearing 10 via a fixed bearing 15. The fixed bearing 15 in the present embodiment is configured as a deep groove ball bearing. Furthermore, the rotor shaft 13 is supported in the second housing portion 14.2 by a floating bearing 16 which is provided on the side of the drive apparatus 7 facing away from the gearing 10.

The rotor shaft 13 in the present embodiment forms an input shaft of the gearing 10. The input shaft 13 is mechanically operatively connected to the first output shaft 5 and the second output shaft 6 via a cylindrical gear gearing 17, the first planetary gear set 70, and the second planetary gear set 80. In the present embodiment, the cylindrical gear gearing 17 has a cylindrical gear 18 and a further cylindrical gear 19 and is thus configured as a single-stage cylindrical gear stage. The further cylindrical gear 19 is non-rotatably connected to the rotor shaft 13 and arranged coaxially thereto. For this purpose, the further cylindrical gear 19 is a hollow shaft and has on its inner circumference an inner toothing which meshes with an outer toothing on the rotor shaft 13. By such a spline, a non-rotatable connection may be established between the rotor shaft 13 and the further cylindrical gear 19. Here, the rotor shaft 13 and the further gear 19 are formed such that the further gear 19 maybe pushed onto the rotor shaft 13 from a side facing away from the drive apparatus 7. The further gear 19 is supported on the first housing portion 14.1 of the gearing 10 via a fixed bearing 20 and is radially supported on the rotor shaft 13. The fixed bearing 20 is configured as a deep groove ball bearing. Furthermore, the gearing 10 has a rotational speed detection apparatus 21 by which the rotational speed of the rotor shaft 13 of the drive apparatus 7 may be detected. The rotational speed detection apparatus 21 is arranged in the axial direction A between the fixed bearing 15 for supporting the rotor shaft 13 and the further gear 19.

The first output shaft 5 in the present embodiment is supported with respect to the second output shaft 6. More specifically, the first output shaft 5 and the second output shaft 6 have an overlap region 22 in the axial direction A, in which overlap region 22 the first output shaft 5 and the second output shaft 6 overlap in the axial direction A. In this overlap region 22, a radial bearing 23 is provided between the output shafts 5, 6, which radial bearing is configured as a needle bearing in the present embodiment. The first output shaft 5 is supported radially with respect to the second output shaft 6 via the radial bearing 23. In the present embodiment, a single radial bearing 23 is arranged in the overlap region 22. Furthermore, the first output shaft 5 and the second output shaft 6 are also mounted axially to each other in the overlap region 22. Thus, the second output shaft 6 has at its end portion facing the first output shaft 5 a diameter reduction for forming a shoulder 24. The shoulder 24 is arranged at the end of the overlap region 22 facing the second output shaft 6. In the present embodiment, the first output shaft 5 extends outside the second output shaft 6 in the overlap region 22 and contacts the shoulder 24. By this contact, an axial force maybe transmitted in a first direction along the axial direction A between the output shafts 5, 6. For the transmission of an axial force in the other direction along the axial direction A, a retaining element 25, in the present case a retaining ring and/or snap ring, is arranged at the end of the second output shaft 6 facing the first output shaft 5 and contacts a corresponding shoulder 26 on the inner circumference of the first output shaft 5. By such a configuration, axial forces maybe transmitted in both axial directions along the axial direction A between the first output shaft 5 and the second output shaft 6.

In the present embodiment, the first output shaft 5 is supported on the second housing portion 14.2 of the gearing 10 via a single radial bearing 27, which is presently configured as a needle bearing. More specifically, the first output shaft 5 is supported directly in the housing 14.1, 14.2 only via this radial bearing 27 and via no further bearing. The radial bearing 27 is provided in the axial direction A at the axial structural height or position of the drive apparatus 7 and at the end of the first output shaft 5 facing away from the planetary gear sets 70, 80. The second output shaft 6 is supported in the first housing portion 14.1 of the gearing 10 via a single fixed bearing 28, which is presently configured as a deep groove ball bearing. More specifically, no further bearing is provided other than the fixed bearing 28, via which the second output shaft 6 is supported directly in the housing 14.1, 14.2. The fixed bearing 28 in the present embodiment is provided at the end of the second output shaft 6 facing away from the planetary gear sets 70, 80. A bending moment introduced into the second output shaft 6, for example via a tripodal support, is transmitted as a radial force pair in addition to the fixed bearing 28 via the radial bearing 23 into the first output shaft 5.

In the present embodiment, the first planetary gear set 70 and the second planetary gear set 80 are arranged adjacent to each other in the axial direction A. Here, the first planetary gear set 70 is arranged in the axial direction A between the second planetary gear set 80 and the drive apparatus 7. The cylindrical gear gearing 17 and the first planetary gear set 70 at least partially overlap each other in the axial direction A. In the radial direction R, the first planetary gear set 70 and the second planetary gear set 80 are formed such that the outer diameters thereof do not differ by more than 20%, for example by no more than 10%. In the present embodiment, the outer diameters of the first planetary gear set 70 and of the second planetary gear set 80 are substantially identical to each other. The first planetary gear set 70 may have a greater inner diameter than the second planetary gear set 80. For example, a tooth engagement of the sun gear 71 of the first planetary gear set 70 is arranged on a greater radial diameter than a tooth engagement of the sun gear 81 of the second planetary gear set 80.

Each of the first planetary gear set 70 and the second planetary gear set 80 in the present embodiment is a minus planetary gear set. Here, a plurality of planetary gears, which mesh both with the respective sun gear 71, 81 and the respective ring gear 73, 83, are respectively provided on the respective planetary carrier 72, 82. In the present embodiment, the planetary gears 74 of the first planetary gear set 70 have a smaller diameter than the planetary gears 84 of the second planetary gear set 80.

Furthermore, in the present embodiment, more planetary gears 74 are provided on the first planetary gear set 70 than on the second planetary gear set 80. For example, the first planetary gear set 70 has five to six planetary gears 74 and the second planetary gear set 80 has three to four planetary gears 84.

The first sun gear 71 of the first planetary gear set 70 has a hub 75 which extends in the axial direction A towards the second planetary gear set 80 and on the radial outer surface of which the toothing of the sun gear 71 is formed. Likewise, the sun gear 81 of the second planetary gear set 80 has a hub 85 which extends in the axial direction A towards the first sun gear 71 and on the radial outer circumference of which the toothing of the first sun gear 71 is formed. The hubs 74, 84 of the sun gears 71, 81 overlap in the axial direction A and are welded to one another. They together form a coupling element 75, 85. Thus, in the present embodiment, the two sun gears 71, 81 are present as an integral member and are permanently, non-rotatably connected to one another.

The hub 75 of the first sun gear 71 has at its end facing the second planetary gear set 80 an abutment portion 76 which is the hub 75 itself. The abutment portion 76 allows the coupling element 75, 85 to abut (run against) the planetary gears 84 of the second planetary gear set 80 in the axial direction A in order to thus support the coupling element 75, 85 in the first direction along the axial direction A. Furthermore, the hub 75 of the sun gear 71 of the first planetary gear set 70 has a thrust ring 77 which is fixed to the hub 75 in the axial direction A by a retaining element. The thrust ring 77 is provided on the end of the coupling element 75, 85 which faces the first planetary gear set 70. The thrust ring 77 allows the coupling element 75, 85 to abut against the planetary gears 74 of the first planetary gear set 70 in the second direction along the axial direction A. Here, the thrust ring 77 is arranged such that axial forces may be received in the other direction along axial direction A by the abutment of the coupling element 75, 85 against the planetary gears 74 of the first planetary gear set 70. The abutment portion 76 and the thrust ring 77 are arranged in the axial direction A between the planetary gears 84 of the second planetary gear set 80 and the planetary gears 74 of the first planetary gear set 70. Thus, the coupling element 75, 85 may be supported in both directions along axial direction A via the thrust ring 77 and the abutment portion 76, which may both abut against the planetary gears 74, 84.

The toothings between the sun gear 71 of the first planetary gear set 70 and the planetary gears 74 of the first planetary gear set 70 and between the sun gear 81 of the second planetary gear set 80 and the planetary gears 84 of the second planetary gear set 80 are configured such that these helical toothings on the sun gears 71, 81 have the same pitches. Thus, the axial forces acting on the coupling element 75, 85 by the toothings of the sun gears 71, 81 may substantially compensate each other. Thus, the abutment portion 76 and the thrust ring 77 are substantially free of axial forces during intended operation.

Thrust plates 78, 88, which enable the respective planetary gears 74, 84 to be supported in both directions along the axial direction A, are provided on the respective planetary carriers 72, 82 of the first planetary gear set 70 and second planetary gear set 80 on each side of the planetary gears 74, 84. Here, the thrust plates 78, 88, which are arranged in the axial direction A between the planetary gears 74 of the first planetary gear set 70 and the planetary gears 84 of the second planetary gear set 80, have recesses for receiving the abutment portion 76 and the thrust ring 77 of the coupling element 75, 85. Via these recesses of the thrust plates 78, 88, an axial displacement of the coupling element 75, 85 along the axial direction A for abutment against the planetary gears 74 of the first planetary gear set 70 and the planetary gears 84 of the second planetary gear set 80 is possible. In order to ensure an intended alignment of the thrust plates 78, 88 with respect to the abutment portion 76 and the thrust ring 77, the thrust plates 78, 88, which have the recesses, are mechanically fixed to the respective planetary carrier 72, 82 in a manner secured against rotation.

The planetary carrier 72 of the first planetary gear set 70 is permanently, non-rotatably connected to the first output shaft 5. In the present embodiment, the non-rotatable connection is effected via a driver toothing 29. In the present embodiment, the driver toothing 29 at least partially overlaps the planetary gears 74 of the first planetary gear set 70 in the axial direction A. For this purpose, the planetary carrier 72 of the first planetary gear set has a radial portion, via which the planetary carrier 72 extends in the radial direction R past the sun gear 71 of the first planetary gear set 70. Furthermore, the planetary carrier 72 of the first planetary gear set 70 has an axial portion in order to extend radially below the sun gear 71 of the first planetary gear set 70 axially towards the second planetary gear set 80. Thus, an engagement via the driver toothing 29 with the first output shaft 5 is enabled, which engagement overlaps the sun gear 71 of the first planetary gear set 70 in the axial direction A. Furthermore, in the present embodiment, a retaining element 30 is provided, which in the present case is a retaining ring and/or snap ring, via which the planetary carrier 72 of the first planetary gear set 70 is fixed in the axial direction A to the first output shaft 5 in both directions along the axial direction A.

In the present embodiment, the planetary carrier 82 of the second planetary gear set 80 is permanently, non-rotatably fastened to the housing, more specifically the first housing portion 14.1, of the gearing 10. For this purpose, the planetary carrier 82 has a radially outwardly extending connecting portion, via which the planetary carrier 82 is permanently, non-rotatably mechanically connected to the first housing portion 14.1, presently screwed. The connecting portion is arranged in the axial direction A between the planetary gears 84 of the second planetary gear set 80 and the planetary gears 74 of the first planetary gear set 70.

The ring gear 83 of the second planetary gear set 80 is permanently, non-rotatably connected to the second output shaft 6. In the present embodiment, for this purpose, the coupling portion 31 is provided which extends radially inwardly from the ring gear 83 in order to non-rotatably connect the ring gear 83 to the second output shaft 6. In the axial direction A, the coupling portion 31 is provided between the fixed bearing 28 and the planetary gears 84 of the second planetary gear set 80.

In the present embodiment, the ring gear 73 of the first planetary gear set 70 is formed integrally, more specifically monolithically, with the cylindrical gear 18 of the cylindrical gear gearing 17. Thus, the cylindrical gear 18 forms a toothing on its radial outer surface which meshes with the further cylindrical gear 19 of the cylindrical gear gearing 17. On its radial inner surface, the cylindrical gear 18 forms the ring gear 73 of the first planetary gear set 70 with a toothing which meshes with the planetary gears 74 of the first planetary gear set. Furthermore, the cylindrical gear 18 forms an intermediate shaft which is mechanically operatively connected to the input shaft 4 via the cylindrical gear gearing 17. The tooth engagements of the cylindrical gear 18 with the further cylindrical gear 19 of the cylindrical gear gearing 17 and of the ring gear 73 of the first planetary gear set 70 with the planetary gears 74 of the first planetary gear set 70 are each helical toothings with substantially identical pitches on the cylindrical gear 18 and the ring gear 73. This leads to the axial forces caused by the toothings, which act on the cylindrical gear 18, substantially compensating each other out.

Furthermore, the cylindrical gear gearing 17 has a support portion 32 which is permanently, non-rotatably connected to the cylindrical gear 18. The support portion 32 has an axial region which extends substantially in the axial direction A and is arranged coaxially and adjacently to the first output shaft 5. The axial region of the support portion 32 is provided radially within the sun gear 71 of the first planetary gear set 70. Furthermore, the support portion 32 has a radial region which extends from the axial region radially outwardly past the sun gear 71 and the planetary carrier 72 of the first planetary gear set 70 in order to permanently, non-rotatably connect the axial region to the cylindrical gear 18. In the axial direction A, the radial region of the support portion 32 is provided between the planetary gears 74 of the first planetary gear set 70 and the drive apparatus 7.

The support portion 32 serves for supporting the cylindrical gear 18 and is designed, for example, for supporting bending moments of the cylindrical gear 18. In the present embodiment, the axial region of the support portion 32 has two radial bearings 33 for this purpose, via which the axial region of the support portion 32 is supported on the first output shaft 5. Here, one of the radial bearings 33 is provided in the present embodiment substantially at the same axial structural height or position as the radial bearing 23, via which the first and the second output shaft 5, 6 are supported radially to each other. Furthermore, the support portion 32 is supported on the housing, more specifically the second housing portion 14.2, via a support bearing 34, which is presently configured as a cylindrical roller bearing with a one-sided thrust shoulder. In the present embodiment, the support portion 32 is supported directly on the housing of the gearing 10 exclusively via the support bearing 34. Furthermore, the first output shaft 5 is indirectly supported on the second housing portion 14.2 via the radial bearing 33, the support portion 32, and the support bearing 34.

In the present embodiment, the cylindrical gear 18 of the cylindrical gear gearing 17 is supported in a floating manner, which simplifies an assembly. In the present embodiment, the cylindrical gear 18 is supported in an axial direction A, in the right direction along axial direction A in FIG. 3, on the second housing portion 14.2 via the support portion 32 and the cylindrical roller bearing 34. For this purpose, a corresponding shoulder is provided on the axial region of the support portion 32, which may abut the cylindrical roller bearing 34 for axial support. In the other axial direction A, in the left direction along axial direction A in FIG. 3, the cylindrical gear 18 of the cylindrical gear gearing 17 may be supported via a thrust ring 35 which is arranged on the further cylindrical gear 19 of the cylindrical gear gearing 17 directly adjacent to the fixed bearing 20. Thus, the cylindrical gear 18 of the cylindrical gear gearing 17 is supported in a floating manner and may be supported in the axial direction A by the thrust ring 35 on the further cylindrical gear 19 and the support bearing 34. Since the axial forces acting on the cylindrical gear 18 on account of the toothing substantially compensate each other out, both the thrust ring 35 and the support bearing 34 are substantially free of axial forces.

Both the thrust ring 35 on the further cylindrical gear 19 of the cylindrical gear gearing 17 and the thrust ring 77 and the abutment portion 76 on the coupling element 75, 85 are configured in the present embodiment to be conical corresponding to a pressure comb, for example with an inclination of less than 5°, in order to enable a friction-optimized point or line contact.

Furthermore, the gearing 10 has a lubricant supply for supplying lubricant into the first output shaft 5. Within the first output shaft 5, the lubricant flows to the radial bearing 23 and from the latter through a gap between the first output shaft 5 and the second output shaft 6 to the coupling element 75, 85, in order to cool the latter on the radial inner side. The coupling element 75, 85 has, in the axial direction A substantially centrally between the sun gears 71, 81, at least one lubricant opening 43 through which the lubricant may pass radially through the coupling element 75, 85 in the radial direction R. From here, the lubricant reaches radially outward in order to be captured by a lubricant catching apparatus 44 attached to the planetary carrier 72 of the first planetary gear set 70. The planetary gears 74 are supported on the planetary carrier 72 via planetary pins. The lubricant captured via the lubricant catching apparatus 44 is supplied via bores provided in the planetary pins to bearings, which support the planetary gears 74 of the first planetary gear set 70 on the planetary pins, for lubrication.

Furthermore, the gearing 10 has a further lubricant supply for supplying lubricant to the planetary carrier 82 of the second planetary gear set 80. For this purpose, an annular channel 79 is provided at a radial end of the second planetary carrier 82, which is supplied with lubricant via the first housing portion 14.1. The planetary gears 84 of the second planetary gear set 80 are supported on the second planetary carrier 82 via pins. In the connecting portion of the second planetary carrier 82, a plurality of bores 89 extending in the radial direction R are provided, which fluidically connect the annular channel 79 via the radial bores 89 in the planetary carrier 82 to bores provided in the pins. The bores provided in the pins supply the bearings, via which the planetary gears 84 of the second planetary gear set are supported on the pins, with lubricant. The lubricant supply for supplying lubricant into the interior of the first output shaft 5 and the further lubricant supply for supplying lubricant to the planetary carrier 82 of the second planetary gear set 80 are supplied with lubricant by the same lubricant source in the present embodiment.

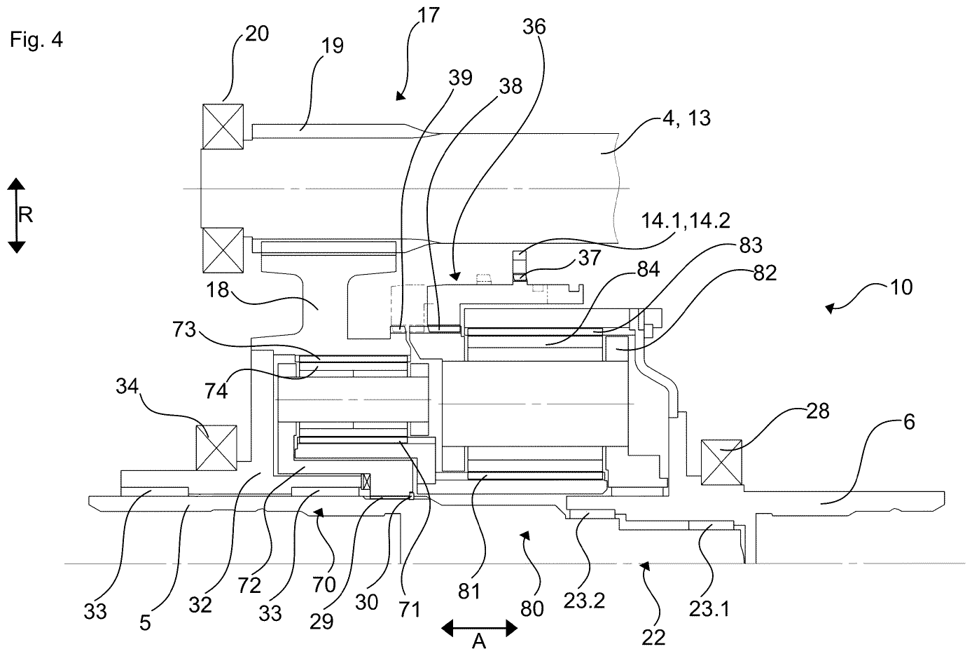

FIG. 4 schematically shows a drivetrain having a gearing 10 having the interconnection of FIG. 2 according to an embodiment of the present disclosure. The embodiment of FIG. 4 corresponds to the embodiment of FIG. 3 with the exception of the differences described in the following. The same reference signs designate corresponding members. In contrast to the embodiment of FIG. 3, in the embodiment of FIG. 4, the first planetary gear set 70 and the second planetary gear set 80 are arranged interchanged to each other in their axial sequence. That is, in the embodiment of FIG. 4, the second planetary gear set 80 is arranged in the axial direction A between the first planetary gear set 70 and the drive apparatus 7 (not shown in FIG. 4). Furthermore, in the embodiment of FIG. 4, the abutment portion 76 and the thrust ring 77 of the coupling element 75, 85 are omitted. Instead, the coupling element 75, 85 is configured to axially abut adjacent members, presently the planetary carrier 72 of the first planetary gear set 70 and the planetary carrier 82 of the second planetary gear set 80.

Furthermore, the embodiment of FIG. 4 is a two-gear variant. For this purpose, a shift apparatus is provided, via which the planetary carrier 82 of the second planetary gear set 80 is selectively non-rotatably connectable to the housing 14.1, 14.2. A shift element 36 of the shift apparatus is axially displaceable in the axial direction A via an actuating device, not shown, for example a shift fork. The shift element 36 is configured as a shifting dog. Here, the shift element 36 has a first spline 37 for selectively non-rotatably engaging a corresponding spline in the housing 14.1, 14.2. Furthermore, the shift element 36 has a second spline 38 for selectively non-rotatably engaging a corresponding toothing of the planetary carrier 82 of the second planetary gear set 80. The splines 37 and 38 are configured here such that they enable an axial displacement of the shift element 36.

Furthermore, in the embodiment of FIG. 4, the cylindrical gear 18 of the cylindrical gear gearing 17, and thus the ring gear 73 of the first planetary gear set 70, has a spline 39 which is configured to non-rotatably engage with the spline 38 of the shift element 36. The shift apparatus of the embodiment of FIG. 4 has three shift positions. In a first shift position, the planetary carrier 82 of the second planetary gear set 80 is non-rotatably connected to the housing 14.1, 14.2 via the splines 37 and 38. In a second shift position, which represents a neutral position, the shift element 36 is still engaged with the planetary carrier 82 of the second planetary gear set 80 via the splines 38. However, the spline 37 is disengaged from the housing 14.1, 14.2, so that there is no non-rotatable connection between the shift element 36 and the housing 14.1, 14.2. In this neutral position, the electric motor may assume any desired rotational speed, for example in order to synchronize one of the gears, or be stationary in order to reduce drag torques. In a third shift position, a non-rotatable connection between the planetary carrier 82 of the second planetary gear set 80 and the cylindrical gear 18 is established via the splines 38, 39 via the shift element 36. In this shift state, the planetary gear sets 70, 80 have no housing support, so that there is a transmission ratio of 1. Accordingly, in this second gear, there is only the transmission of the cylindrical gear gearing 17. The first gear, the neutral position and the second gear may be shifted one after the other in this sequence by a displacement of the shift element 36 in an axial direction.

Furthermore, in the embodiment of FIG. 4, the first output shaft 5 is supported within the second output shaft 6. In this embodiment, two radial bearings 23.1, 23.2 are provided in the overlap region 22 of the two output shafts 5, 6. Thereby, the radial bearing 27 may be omitted in the first output shaft 5. Instead, in the embodiment of FIG. 4, the second output shaft 6 is supported directly in the housing 14.1, 14.2 only via a single bearing, namely the fixed bearing 28. Thus, a bending moment, which is introduced into the second output shaft 6, maybe transmitted via the two radial bearings 23.1, 23.2 to the first output shaft 5 and supported thereby. Otherwise, reference is made to the statements in connection with the embodiment of FIG. 3.

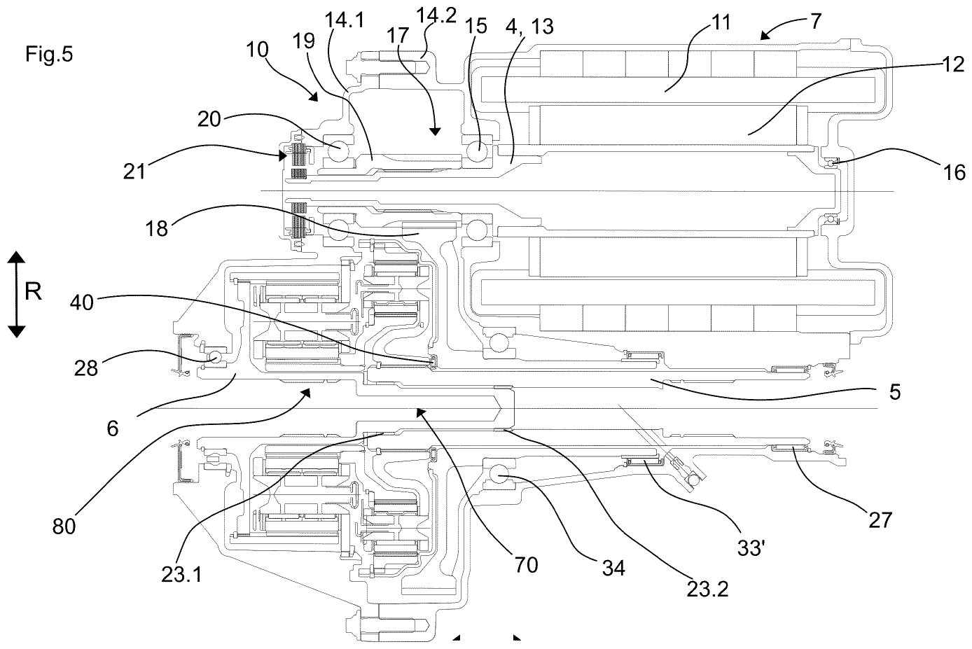

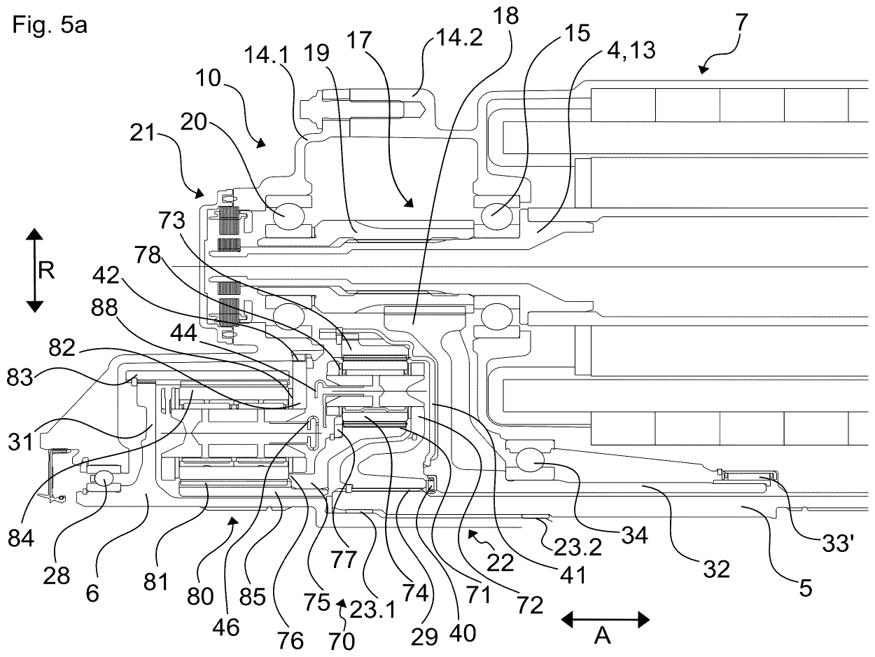

FIG. 5 schematically shows a drivetrain having a gearing 10 having the interconnection of FIG. 2 according to an embodiment of the present disclosure. FIG. 5a shows the gearing of the drivetrain of FIG. 5 in a detailed view. The present embodiment will be described in the following with reference to FIGS. 5 and 5a. The embodiment of FIGS. 5, 5a is identical to the embodiment of FIGS. 3, 3a with the exception of the differences described in the following. The same reference signs designate corresponding members. In contrast to the embodiment of FIGS. 3, 3a, the support portion 32 of the cylindrical gear gearing 17 in the present embodiment is not supported on the first output shaft 5. Instead, in addition to the support bearing 34, a radial bearing 33′is provided, which is presently configured as a needle bearing. Via the radial bearing 33′, the support portion 32 is directly supported on the housing of the gearing, more specifically the second housing portion 14.2. Thus, a particularly stiff support having advantageous acoustics and service life maybe provided. Furthermore, the cylindrical gear 18 of the cylindrical gear gearing 17 in the present embodiment is formed with ribs for increasing its stiffness.

Furthermore, in the present embodiment, an axial bearing 40 is provided between the planetary carrier 72 of the first planetary gear set 70 and the support portion 32, via which the planetary carrier 72 of the first planetary gear set 70 and the support portion 32 of the cylindrical gear gearing 17 are supported relative to each other in the axial direction A. The axial bearing 40 in the present embodiment is configured as an axial needle bearing. Via the axial needle bearing 40 and the support bearing 34, the cylindrical gear 18 is axially fixed in the axial direction A by the support portion 32. Thus, in the embodiment according to FIG. 5, the thrust ring 35 provided on the further cylindrical gear 19 of the cylindrical gear gearing 17 for axially fixing the cylindrical gear 18 may be omitted.

Furthermore, the second output shaft 6 is supported in and relative to the first output shaft 5 in the overlap region 22 in the embodiment of FIG. 5 via two bearings 23.1, 23.2, which in the present case are plain bearings. Such a configuration makes it possible that each of the output shafts 5, 6 only has to be supported on the housing 14.1, 14.2 via one bearing, presently the radial bearing 27 and the fixed bearing 28. In contrast to the embodiment of FIGS. 5, 5a, in the embodiment according to FIGS. 3, 3a, the first output shaft 5 is additionally indirectly supported on the housing 14.1, 14.2 via the radial bearing 33 and the support bearing 34. The latter may be omitted in the embodiment according to FIG. 5.

Furthermore, in the embodiment according to FIG. 5, the cylindrical gear 18 and the ring gear 73 of the first planetary gear set 70 are non-rotatably connected to one another via a separate carrier element 41. In the present embodiment, the carrier element 41 is configured as a carrier plate and extends from the axial region of the support portion 32 in the radial direction to the ring gear 73 of the first planetary gear set 70 in order to establish a non-rotatable connection between these components. By the carrier plate 41, the ring gear 73 of the first planetary gear set 70 receives an additional decoupling point in order to be able to align itself better. For this purpose, the carrier plate may be mounted in the ring gear 73 for the non-rotatable connection, but allow a relative axial and radial clearance. This improves the acoustics and service life. Furthermore, in the embodiment according to FIG. 5, the ring gear 73 of the first planetary gear set 70 is arranged close to the cylindrical gear 18 or the support portion 32 thereof in the axial direction A. This has the advantage that a deformation or displacement of the cylindrical gear 18 on account of tooth forces has only a slight effect on the shape and position of the ring gear 73 of the first planetary gear set 70.

Furthermore, in the embodiment of FIG. 5, the coupling portion 31 is formed integrally, presently monolithically, with the output shaft 6, which leads to a cost saving. In the present embodiment, the planetary carrier 82 of the second planetary gear set 80 is non-rotatably fixed to the housing 14.1, 14.2 via a driver toothing 42. In the axial direction, the planetary carrier 82 of the second planetary gear set 80 is secured via a retaining element, presently a snap ring. Thus, an acoustic decoupling maybe provided. Furthermore, in the embodiment of FIG. 5, the rotational speed detection apparatus 21 is provided at the end of the rotor shaft 13 facing away from the stator 11. This enables an easier accessibility and furthermore a smaller dimensioning, which may lead to reduced costs.

In the embodiment according to FIG. 5, the lubricant supply to the planetary pin of the planetary gears 84 of the second planetary gear set 80 is effected via a separate member, in the present case via a plastic member 46, which in the present case is connected to the planetary carrier 82 of the second planetary gear set 80. The aperture cross-sections of the plastic member 46 limit the lubricant flow to the planetary pins of the second planetary gear set 80. Via the plastic member 46, a fluid-conducting connection to a housing-fixed oil channel is provided. Furthermore, the separate plastic member 46 in the present embodiment defines at least one opening which enables lubricant to be supplied to the lubricant catching apparatus 44. Since the lubricant catching apparatus 44 is supplied with lubricant by the plastic member 46, only a small lubricant flow is still required in the interior of the first output shaft 5. It is therefore possible that the lubricant supply to the first output shaft 5 is effected by providing a housing-fixed lubricant nozzle which conveys lubricant through openings on the circumference of the first output shaft 5 into the interior of the output shaft 5. Thus, rectangular ring seals maybe omitted, which leads to a reduction of costs, a simplification of assembly and a reduction of drag torques.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE SIGNS

1 vehicle
4 input shaft
5, 6 output shaft
7 drive apparatus
8, 9 wheel
10 gearing
11 stator
12 rotor
13 rotor shaft
14.1, 14.2 housing portion
15 fixed bearing
16 floating bearing
17 cylindrical gear gearing
18 cylindrical gear
19 further cylindrical gear
20 fixed bearing
21 rotational speed detection apparatus
22 overlap region
23, 23.1, 23.2 radial bearing
24 shoulder
25 retaining element
26 shoulder
27 radial bearing
28 fixed bearing
29 driver toothing
30 retaining element
31 coupling portion
32 support portion
33, 33′ radial bearing
34 support bearing
35 thrust ring
36 shift element
37, 38, 39 spline
40 axial bearing
41 carrier element
42 driver toothing
43 lubricant opening
44 lubricant catching apparatus
46 plastic member
70, 80 planetary gear set
71, 81 first element of the first/second planetary gear set, e.g. sun gear
72, 82 second element of the first/second planetary gear set, e.g. planetary carrier
73, 83 third element of the first/second planetary gear set, e.g. ring gear
74, 84 planetary gear
75, 85 coupling element
76 abutment Portion
77 thrust ring
78, 88 thrust plate
79 annular channel
89 radial bore
A axial direction
R radial direction

1-34. (canceled)

35. A gearing (10) for a vehicle (1), comprising:
an input shaft (4);
an intermediate shaft (18);
two output shafts including a first output shaft (5) and a second output shaft (6);
a first planetary gear set (70) comprising a first element (71), a second element (72), and a third element (73), the intermediate shaft (18) being mechanically operatively connected to the third element (73) of the first planetary gear set (70), the first output shaft (5) being mechanically operatively connected to the second element (72) of the first planetary gear set (70);
a second planetary gear set (80) comprising a first element (81), a second element (82), and a third element (83), the first element (71) of the first planetary gear set (70) being mechanically operatively connected to the first element (81) of the second planetary gear set (80), the second output shaft (6) being mechanically operatively connected to the third element (83) of the second planetary gear set (80); and
a cylindrical gear gearing (17), the input shaft (4) being mechanically operatively connected to the intermediate shaft (18) via the cylindrical gear gearing (17),
wherein the gearing (10) has a transmission ratio between the input shaft (4) and the two output shafts (5, 6), the transmission ratio having an absolute value greater than ten.

36. The gearing (10) of claim 35, wherein the gearing (10) is configured to transmit a power from the intermediate shaft (18) to the two output shafts (5, 6) with a distributor transmission ratio, an absolute value of a transmission ratio of the cylindrical gear gearing (17) being greater than an absolute value of the distributor transmission ratio.

37. The gearing (10) of claim 35, wherein the cylindrical gear gearing (17) comprises a cylindrical gear (18), the cylindrical gear (18) being permanently, non-rotatably connected to the third element (73) of the first planetary gear set (70), the cylindrical gear (18) forming the intermediate shaft.

38. The gearing (10) of claim 37, wherein the cylindrical gear (18) and the third element (73) of the first planetary gear set (70) are integrally formed.

39. The gearing (10) of claim 37, further comprising a separate carrier element (40), the cylindrical gear (18) being non-rotatably connected to the third element (73) of the first planetary gear set (70) via the separate carrier element (40).

40. The gearing (10) of claim 37, wherein toothed portions of the cylindrical gear (18) and of the third element (73) of the first planetary gear set (70) have substantially equal pitches such that axial forces of engagement of the toothed portions of the cylindrical gear (18) and of the third element (73) of the first planetary gear set (70) substantially cancel each other out.

41. The gearing (10) of claim 37, wherein the cylindrical gear gearing (17) comprises a support portion (32), the support portion (32) being permanently non-rotatably connected to the cylindrical gear (18), the support portion (32) being supported on a shaft (5) for supporting a bending moment of the cylindrical gear (18).

42. The gearing (10) of claim 41, wherein the shaft is the first output shaft (5).

43. The gearing (10) of claim 41, wherein the cylindrical gear (18) is supported directly on a stationary member (14.1, 14.2) with only a single bearing (34).

44. The gearing (10) of claim 41, wherein the cylindrical gear (18) is supported in an axially floating manner.

45. The gearing (10) of claim 44, further comprising a thrust ring (35),
wherein the cylindrical gear gearing (17) comprises a further cylindrical gear (19) which meshes with the cylindrical gear (18), the cylindrical gear (18) being supported on the further cylindrical gear (19) in an axial direction (A) via the thrust ring (35).

46. The gearing (10) of claim 45, wherein the cylindrical gear (18) is supported on a stationary member (14.1, 14.2) in another axial direction (A) via only a single bearing (34).

47. The gearing (10) of claim 41, further comprising an axial bearing (40), the second element (72) of the first planetary gear set (70) being axially supported on the support portion (32) via the axial bearing (40).

48. The gearing (10) of claim 35, further comprising a retaining element (30), the second element (72) of the first planetary gear set (70) being fixed to the first output shaft (5) in at least one axial direction (A) via the retaining element (30).

49. The gearing (10) of claim 35, wherein the first output shaft (5) is supported with respect to the second output shaft (6).

50. The gearing (10) of claim 49, further comprising one or two radial bearings (23; 23.1, 23.2) for radially supporting the first output shaft (5) with respect to the second output shaft (6).

51. The gearing (10) of claim 50, wherein the first output shaft (5) and the second output shaft (6) overlap each other axially at an overlap region (22), the one or two radial bearings (23; 23.1, 23.2) being in the overlap region (22).

52. The gearing (10) of claim 49, wherein axial forces transmission between the two output shafts (5, 6) is possible in at least one axial direction (A).

53. The gearing (10) of claim 52, further comprising at least one of an axial abutment, a snap ring, a retaining ring, or a screw connection for the axial force transmission.

54. The gearing (10) of claim 35, wherein toothed portions of the first element (71) of the first planetary gear set (70) and of the first element (81) of the second planetary gear set (80) have substantially equal pitches such that axial forces of engagements of the toothed portions of the first element (71) of the first planetary gear set (70) and of the first element (81) of the second planetary gear set (80) substantially cancel each other out.

55. The gearing (10) of claim 54, wherein at least one of the first elements (71; 81) of the first or second planetary gear sets (70; 80) is supported in one axial direction via at least one of an abutment on a planetary gear (74; 84) of the first and second planetary gear sets (70; 80), an abutment on a planetary carrier (72; 82) of the first and second planetary gear sets (70, 80), or an axial bearing.

56. The gearing (10) of claim 35, wherein the first planetary gear set (70) comprises more planetary gears (74) than the second planetary gear set (80).

57. The gearing (10) of claim 35, further comprising a shift element (36), the second element (82) of the second planetary gear set (80) being selectively non-rotatably connectable to a stationary member (14.1, 14.2) via the shift element (36).

58. The gearing (10) of claim 57, wherein the second element (82) of the second planetary gear set (80) is selectively non-rotatably connectable to the third element (73) of the first planetary gear set (70) via the shift element (36).

59. The gearing (10) of claim 35, wherein the gearing (10) comprises a lubricant supply for supplying lubricant into the first output shaft (5) and to at least one gearing element (71; 81).

60. The gearing (10) of claim 59, further comprising a housing-fixed lubricant nozzle,
wherein the first output shaft (5) defines an opening, the housing-fixed lubricant nozzle supplying lubricant through the opening into the first output shaft (5).

61. The gearing (10) of claim 59, further comprising a lubricant catching apparatus (44) for catching lubricant for lubricating an element of one of the first and second planetary gear sets (70).

62. The gearing (10) of claim 61, further comprising a further lubricant supply for supplying lubricant to the second element (82) of the second planetary gear set (80), the further lubricant supply guiding lubricant to the lubricant catching apparatus (44).

63. The gearing (10) of claim 62, wherein the further lubricant supply comprises a separate plastic member (46) which is mechanically connected to the second element (82) of the second planetary gear set (80).

64. The gearing (10) of claim 35, wherein the second element (82) of the second planetary gear set (80) is non-rotatably connected or non-rotatably connectable to a stationary member (14.1), and wherein the first element (71) of the first planetary gear set (70) is permanently non-rotatably connected to the first element (81) of the second planetary gear set (80).

65. The gearing (10) of claim 64, wherein the first element (71, 81) of each of the first and second planetary gear sets (70, 80) is a sun gear.

66. The gearing (10) of claim 65, wherein the second element (72, 82) of each of the first and second planetary gear sets (70, 80) is a planetary carrier and the third element (73, 83) of each of the first and second planetary gear sets (70, 80) is a ring gear.

67. A drivetrain, comprising:
a drive apparatus (7); and
the gearing (10) of claim 35.

68. A vehicle (1), comprising the gearing (10) of claim 35.
